(19) United States
(12) Patent Application Publication
(10) Pub. No.: US 2014/0096794 A1
(43) Pub. Date: Apr. 10, 2014

(54) Methods for Cleaning a Contaminated Surface

(71) Applicant: The Boeing Company, (US)

(72) Inventor: Sergey G. Ponomarev, Seattle, WA (US)

(73) Assignee: THE BOEING COMPANY, Chicago, IL (US)

(21) Appl. No.: 13/644,268

(22) Filed: Oct. 4, 2012

(51) Int. Cl. B08B 7/00

(52) U.S. Cl. 134/6

(57) ABSTRACT

A method for cleaning a contaminated surface is provided. The method includes covering at least a portion of the contaminated surface with an absorptive medium. At least a portion of the absorptive medium is saturated with a cleaning solution before the portion of the contaminated surface is covered with the absorptive medium, or at least a portion of the absorptive medium is saturated with a cleaning solution after the portion of the contaminated surface is covered with the absorptive medium. Steam is applied to the saturated absorptive medium for a period of time to facilitate removing contaminants from the contaminated surface and to facilitate transferring the contaminants to the absorptive medium, wherein the saturated absorptive medium is substantially stationary relative to the contaminated surface as steam is applied to the saturated absorptive medium

### BACKGROUND

The field of the disclosure relates generally to cleaning methods and, more specifically, a method for cleaning a contaminated surface that facilitates reducing chemical waste.

Cleaning operations are generally used to improve the aesthetic appearance of, and to prepare contaminated surfaces for further processing. Conventional methods for cleaning a contaminated surface generally fall into two categories, mechanical and chemical. Mechanical cleaning generally includes physically removing and/or collecting contaminants with a cloth or other suitable material, and chemical cleaning generally involves using a solvent to break down contamination such that it may be more easily removed from the contaminated surface. Generally, both mechanical and chemical cleaning methods may be used simultaneously to perform a desired cleaning operation.

With respect to cleaning large contaminated surfaces, some known operations used to remove contaminants may include initially applying a cleaning chemical to the contaminated surface and allowing the cleaning chemical to remain on the contaminated surface for a predetermined period of time to break down the contamination. The chemical and broken down contaminants are then rinsed away. However, such cleaning processes may produce a large amount of chemical waste that may be costly to dispose of

In another known cleaning operation, a microfiber medium is attached to a steam cleaning apparatus such that the microfiber medium can be rubbed against a contaminated surface while steam is delivered thereto. This known cleaning operation generally does not use chemicals or detergents to facilitate cleaning the contaminated surface. However, in at least some known cleaning operations, the use of only steam and mechanical rubbing may not be sufficient to clean or strip a contaminated surface.

### BRIEF DESCRIPTION

In one aspect, a method for cleaning a contaminated surface is provided. The method includes covering at least a portion of the contaminated surface with an absorptive medium. At least a portion of the absorptive medium is saturated with a cleaning solution before the portion of the contaminated surface is covered with the absorptive medium, or at least a portion of the absorptive medium is saturated with a cleaning solution after the portion of the contaminated surface is covered with the absorptive medium. Steam is applied to the saturated absorptive medium for a period of time to facilitate removing contaminants from the contaminated surface and to facilitate transferring the contaminants to the absorptive medium, wherein the saturated absorptive medium is substantially stationary relative to the contaminated surface as steam is applied to the saturated absorptive medium.

In another aspect, a method for cleaning a contaminated surface is provided. The method includes covering at least a portion of the contaminated surface with an absorptive medium. At least a portion of the absorptive medium is saturated with a cleaning solution before the portion of the contaminated surface is covered with the absorptive medium, or at least a portion of the absorptive medium is saturated with a cleaning solution after the portion of the contaminated surface is covered with the absorptive medium. Steam is applied to the saturated absorptive medium for a period of time to facilitate removing contaminants from the contaminated surface and to facilitate transferring the contaminants to the absorptive medium, wherein the saturated absorptive medium is substantially stationary relative to the contaminated surface as steam is applied to the saturated absorptive medium. At least one of pressure or friction is applied to the saturated absorptive medium to facilitate removing contaminants from the contaminated surface

### BRIEF DESCRIPTION OF THE DRAWINGS

FIG. 1 is a perspective view of an exemplary steam cleaning system that may be used to clean a contaminated surface.

FIG. 2 is a sectional view of the steam cleaning system shown in FIG. 1.

FIG. 3 is a flow diagram of an exemplary method of cleaning a contaminated surface that may be used with the steam cleaning system shown in FIG. 2.

FIG. 4 is a sectional view of an alternative exemplary steam cleaning system.

FIG. 5 is a flow diagram of an exemplary method of cleaning a contaminated surface that may be used with the steam cleaning system shown in FIG. 4.

### DETAILED DESCRIPTION

At least some implementations of the present disclosure relate to methods for cleaning a surface from contamination and/or removing organic coatings from substrates. In the exemplary method, a contaminated surface is covered with an absorptive medium that has been pre-saturated with a predetermined cleaning solution. Steam is applied to the absorptive medium for a predetermined period of time, and the steam and the medium are removed from the contaminated surface to produce a surface that is substantially free from contaminants. When the method is used to remove an organic coating from a substrate, the coating debonds from the substrate and adheres to the absorptive medium. The composition of the cleaning solution is variably selected (e.g. predetermined) to enable the solution to be used in a plurality of different cleaning operations. The absorptive medium facilitates reducing chemical waste by collecting the surface contaminants and the cleaning solution therein.

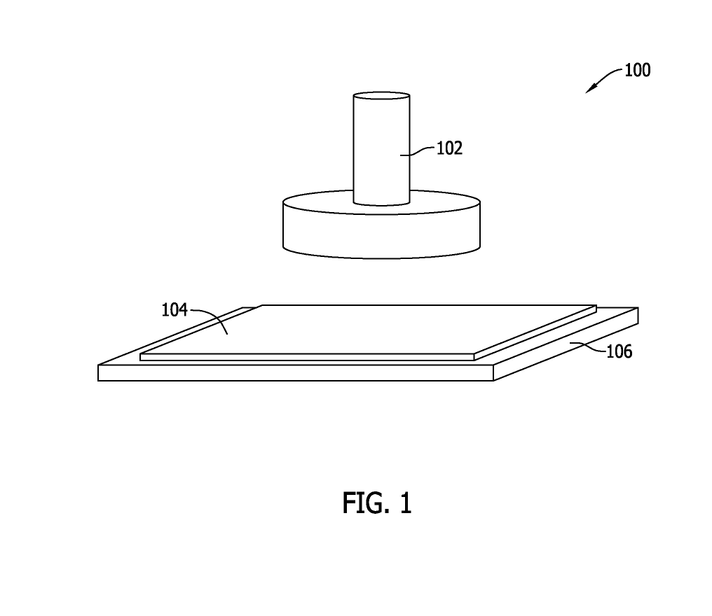

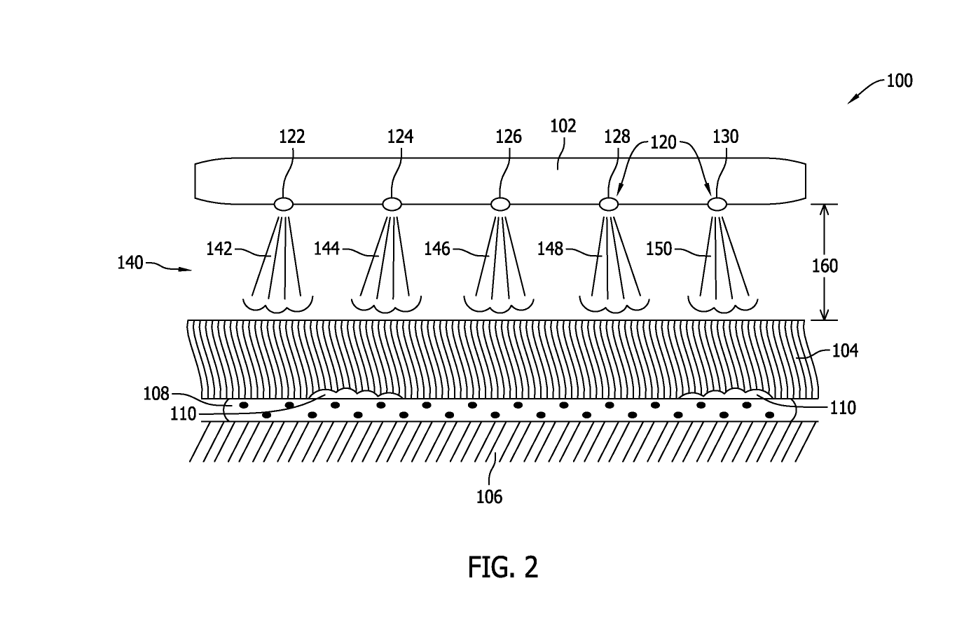

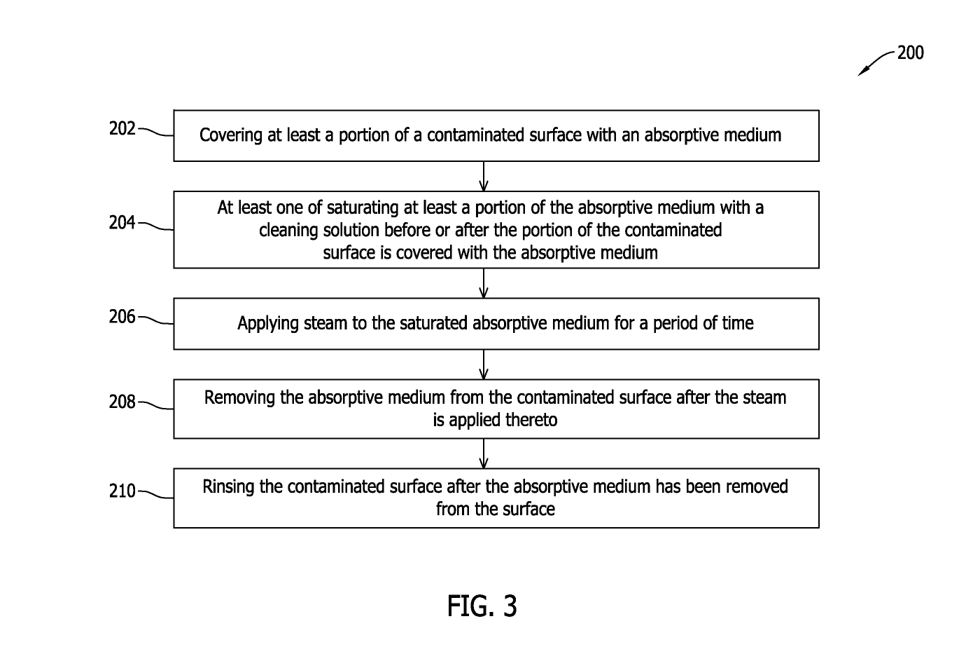

FIG. 1 is a perspective view of an exemplary steam cleaning system 100, FIG. 2 is a sectional view of steam cleaning system 100, and FIG. 3 is a flow diagram of an exemplary method 200 that may be used to clean a contaminated surface 106 using steam cleaning system 100. In the exemplary implementation, steam cleaning system 100 includes a steam jet head 102 and an absorptive medium 104. Steam jet head 102 includes a plurality of jet nozzles 120 that direct steam jets 140 towards absorptive medium 104. More specifically, in the exemplary implementation, steam jet head 102 includes a fives jet nozzles 122, 124, 126, 128, 130. As such, jet nozzle 122 directs a first steam jet 142 towards absorptive medium 104, jet nozzle 124 directs a second steam jet 144 towards absorptive medium 104, jet nozzle 126 directs a third steam jet 146 towards absorptive medium 104, jet nozzle 128 directs a fourth steam jet 148 towards absorptive medium 104, and jet nozzle 130 directs a fifth steam jet 150 towards absorptive medium 104. Although system 100 is shown as including five jet nozzles 120, steam jet head 102 may include any suitable number of jet nozzles 120 that enables system 100 to function as described herein.

In the exemplary implementation, absorptive medium 104 may be any permeable or semi-permeable medium that is capable of retaining a cleaning solution therein. For example, in one implementation, a suitable absorptive medium 104 includes, but is not limited to, a microfiber material, a napkin, a cloth, a towelette, a tissue, paper, or any other suitable material that enables steam cleaning system 100 to function as described herein. In the exemplary embodiment, absorptive medium 104 is a WypAll® L40 All-Purpose Wiper (“WypAll” is a registered trademark of Kimberly-Clark Worldwide, Inc. of Neenah, Wis.). Moreover, in the exemplary implementation, absorptive medium 104 includes a predetermined cleaning solution therein. The predetermined cleaning solution may be any suitable cleaning solution that enables steam cleaning system 100 to function as described herein. For example, in one implementation, the cleaning solution includes a mixture of water and a predetermined cleaning chemical. Suitable cleaning chemicals include, but are not limited to, an alcohol, a hydroxide, a detergent, a peroxide, and a surfactant. In the exemplary implementation, the cleaning chemical is Windex® with Ammonia-D® (“Windex” and “Ammonia-D” are registered trademarks of S.C. Johnson & Son, Inc. of Racine, Wis.).

Steam jet head 102 directs steam jets 140 towards absorptive medium 104 to facilitate cleaning and/or stripping contaminated surface 106. More specifically, in the exemplary implementation, contaminated surface 106 includes a layer 108 of contaminants 110 formed or deposited thereon, and absorptive medium 104 is sized to cover at least a portion of contaminated surface 106 adjacent to contamination layer 108.

During operation, method 200 may be used with steam cleaning system 100 to facilitate cleaning an article, such as contaminated surface 106. In the exemplary implementation, absorptive medium 104 is sized to cover 202 at least a portion of contaminated surface 106. For example, absorptive medium 104 is sized to extend over at least a portion of contaminated surface 106 that includes contamination layer 108 formed thereon. At least a portion of absorptive medium 104 is saturated 204 with the predetermined cleaning solution either before, or after the portion of contaminated surface 106 is covered 202 with absorptive medium 104. As used herein, the term “saturated” refers to the process of applying any suitable amount of a predetermined cleaning solution to absorptive medium 104, and does not necessarily refer to applying the greatest possible amount of predetermined cleaning solution to absorptive medium 104, As will be understood by one of ordinary skill in the art, absorptive medium 104 may be saturated 204 with any suitable amount of predetermined cleaning solution that enables system 100 to function as described herein. For example, in one implementation, the amount of predetermined cleaning solution applied to medium 104 is sufficient to remove contaminants 110 from contaminated surface 106, but not enough to result in oversaturating absorptive medium 104. Accordingly, saturating 204 absorptive medium 104 with the predetermined cleaning solution facilitates reducing chemical waste in comparison to known cleaning operations.

Method 200 also includes applying 206 steam to saturated absorptive medium 104 for a predetermined period of time such that contaminants 110 removed from contaminated surface 106 are transferred to absorptive medium 104. In the exemplary implementation, steam is applied 206 to absorptive medium 104 to facilitate forcing the predetermined cleaning solution from saturated absorptive medium 104 onto contaminated surface 106. As such, as the steam and cleaning solution breaks down contamination layer 108, contaminants 110 dissolved in the steam and predetermined cleaning solution mixture are transferred from contaminated surface 106 into absorptive medium 104.

In the exemplary implementation, steam is directed from steam jet head 102 towards medium 104. In one implementation, steam jet head 102 is positioned a predetermined distance 160 from absorptive medium 104, and steam jets 140 are directed towards absorptive medium 104 at any suitable pressure that enables steam cleaning system 100 to function as described herein. As will be appreciated by one of ordinary skill in the art, predetermined distance 160 and the predetermined pressure of steam jets 140 is dependent upon the particular cleaning operation for which steam cleaning system 100 is being used. For example, increasing the discharge pressure of steam jets 140 may facilitate reducing the period of time that may be required to clean a covered portion of contaminated surface 106. Furthermore, as distance 160 is increased, the steam jet pressure may also be required to be increased to facilitate cleaning contaminated surface 106. For example, in one implementation, the predetermined discharge pressure of steam jets 140 is at least 30 pounds per square inch (psi). In some implementations, the predetermined pressure may be up to about 500 psi.

In one implementation, medium 104 is positioned substantially stationary relative to contaminated surface 106 as steam is directed towards medium 104. More specifically, as steam jets 140 are directed towards absorptive medium 104, the discharge jet pressure forces the predetermined cleaning solution from saturated absorptive medium 104 towards surface 106 to facilitate breaking down contamination layer 108 mechanically. Absorptive medium 104 remains substantially stationary during the cleaning process to ensure the predetermined cleaning solution is applied to contaminated surface 106 for a sufficient period of time to break down contaminants 110 and to enable the contaminants 110 to be transferred to absorptive medium 104 via a capillary action of medium 104.

Absorptive medium 104 is removed 208 from contaminated surface 106 after the steam has been applied 206 thereto for the predetermined amount of time. As described above, absorptive medium 104 absorbs contaminants 110 transferred and released from contaminated surface 106. As such, when medium 104 is removed 208 from contaminated surface 106, the transferred contaminants 110 are likewise removed from surface 106. Accordingly, transferring contaminants 110 to absorptive medium 104 facilitates reducing the exposure of contaminants 110 to the ambient environment as contamination layer 108 is broken down and removed from surface 106.

Surface 106 may then be rinsed 210 after absorptive medium 104 is removed from therefrom. In the exemplary implementation, rinsing 210 is at least partially accomplished by directing steam jets 140 towards surface 106.

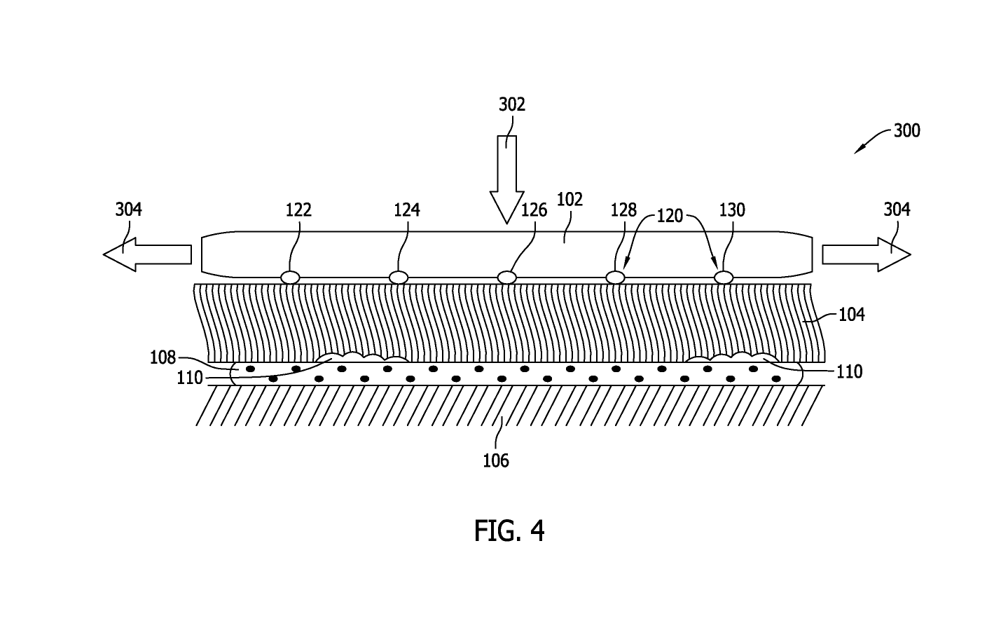

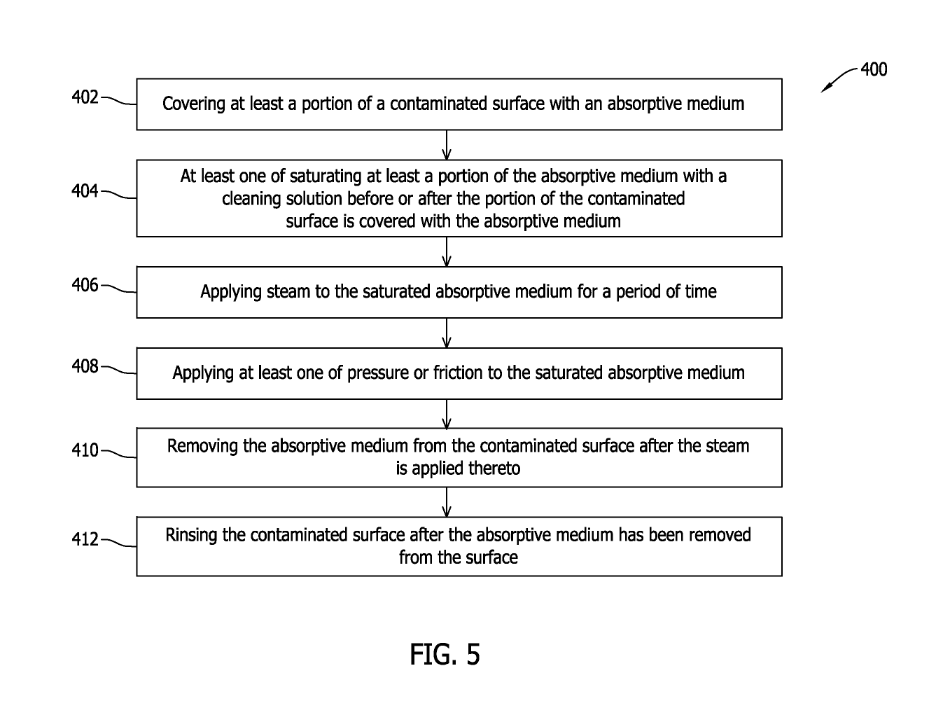

FIG. 4 is a perspective view of an exemplary steam cleaning system 300, and FIG. 5 is a flow diagram of an exemplary method 400 for cleaning contaminated surface 106 that may be used with steam cleaning system 300. Similar to steam cleaning system 100, in the exemplary implementation, steam cleaning system 300 includes steam jet head 102, absorptive medium 104, contaminated surface 106, and contamination layer 108 formed thereon. In the exemplary implementation, steam jet head 102 contacts medium 104 such that steam jet head 102 can apply at least one of pressure 302 or friction 304 to absorptive medium 104 to facilitate removing contaminants 110 from contaminated surface 106.

During operation, method 400 may be used with steam cleaning system 300 to facilitate cleaning an article, such as contaminated surface 106. In the exemplary implementation, absorptive medium 104 is sized to cover 402 at least a portion of contaminated surface 106. For example, absorptive medium 104 is sized to extend over at least a portion of contaminated surface 106 that includes contamination layer 108 formed thereon. At least a portion of absorptive medium 104 is saturated 404 with the predetermined cleaning solution either before, or after the portion of contaminated surface 106 is covered 402 with absorptive medium 104.

Method 400 also includes applying 406 steam to saturated absorptive medium 104 for a predetermined period of time such that contaminants 110 removed from contaminated surface 106 are transferred to absorptive medium 104. In the exemplary implementation, steam is applied 406 to absorptive medium 104 to facilitate forcing the predetermined cleaning solution from saturated absorptive medium 104 onto contaminated surface 106. As such, as the steam and cleaning solution breaks down contamination layer 108, contaminants 110 dissolved in the steam and predetermined cleaning solution mixture are transferred from contaminated surface 106 into absorptive medium 104.

In the exemplary implementation, steam is directed from steam jet head 102 towards medium 104. Method 400 also includes applying 408 at least one of pressure 302 or friction 304 to medium 104 to facilitate removing contaminants 110 from contaminated surface 106. In the exemplary implementation, steam is applied 406 to saturated absorptive medium 104 simultaneously with applying 408 at least one of pressure 302 or friction 304 to medium 104. Although friction 304 is shown as being applied 408 in two directions in the exemplary implementation, one of ordinary skill in the art will understand that friction 304 may be applied 408 in any suitable direction with respect to medium 104 such that contaminants 110 may be removed from contaminated surface 106.

Furthermore, as will be appreciated by one of ordinary skill in the art, the amount of pressure 302 and/or friction 304 applied 408 to absorptive medium 104 is dependent upon a particular cleaning operation for which steam cleaning system 300 is being used. For example, increasing the pressure 302 or friction 304 applied 408 to absorptive medium 104 from steam jet head 102 would facilitate reducing the amount of time that may be required to clean a covered portion of contaminated surface 106.

In one implementation, medium 104 is positioned substantially stationary relative to contaminated surface 106 as steam is directed towards medium 104. More specifically, as steam jets 140 are directed towards absorptive medium 104, the discharge jet pressure forces the predetermined cleaning solution from saturated absorptive medium 104 towards surface 106 to facilitate breaking down contamination layer 108 mechanically. Absorptive medium 104 remains substantially stationary during the cleaning process to ensure the predetermined cleaning solution is applied to contaminated surface 106 for a sufficient period of time to break down contaminants 110 and to enable the contaminants 110 to be transferred to absorptive medium 104 via a capillary action of medium 104.

Absorptive medium 104 is removed 410 from contaminated surface 106 after the steam has been applied 406 thereto for the predetermined amount of time. As described above, absorptive medium 104 absorbs contaminants 110 transferred and released from contaminated surface 106. As such, when medium 104 is removed 410 from contaminated surface 106, the transferred contaminants 110 are likewise removed from surface 106. Accordingly, transferring contaminants 110 to absorptive medium 104 facilitates reducing the exposure of contaminants 110 to the ambient environment as contamination layer 108 is broken down and removed from surface 106.

Surface 106 may then be rinsed 412 after medium 104 is removed 410 therefrom. In the exemplary implementation, rinsing 412 includes extending a second absorptive medium over the portion of surface 106 that absorptive medium 104 was removed 410 from. In the exemplary implementation, the second absorptive medium is constructed from the same material as absorptive medium 104, and in an alternative embodiment, the second absorptive medium is constructed of any suitable material that enables steam cleaning system 300 to function as described herein. At least a portion of the second absorptive medium is saturated with a predetermined rinsing solution either before or after the portion of surface 106 is covered with the second absorptive medium. Steam is then applied to the second absorptive medium for a predetermined period of time such that the predetermined cleaning solution and any residual contaminants 110 are removed from contaminated surface 106 and transferred to the second absorptive medium.

The predetermined rinsing solution may be any suitable rinsing solution that enables steam cleaning system 300 to function as described herein. For example, suitable rinsing solutions include, but are not limited to, water, ethyl alcohol, ethyl lactate, and combinations thereof. In the exemplary embodiment, the predetermined rinsing solution is water.

The cleaning methods described herein facilitate cleaning and/or stripping the contaminated surface in a manner that facilitates reducing the amount of chemical waste generated by the cleaning/stripping process as compared to known cleaning methods. More specifically, the methods described herein include saturating an absorptive medium with a predetermined cleaning solution, covering the contaminated surface with the saturated absorptive medium, and applying steam to the saturated absorptive medium. By applying steam to the saturated absorptive medium, the predetermined cleaning solution is forced towards the contaminated surface such that the combination of steam and the cleaning solution facilitates breaking down and dissolving the contaminants formed on the surface to be cleaned/stripped. Furthermore, in one implementation, the broken-down contaminants are dissolved in the steam and cleaning solution mixture and then drawn into the absorptive medium via capillary action. As such, the methods described herein facilitate preventing the use of an excessive amount of predetermined cleaning solution and thus reduces the costs associated with cleaning the contaminated surface and/or disposal of waste products. Furthermore, by collecting broken-down contaminants and used cleaning solution in the absorptive medium, the methods described herein facilitate reducing the generation of chemical waste.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for cleaning a contaminated surface, said method comprising:
covering at least a portion of the contaminated surface with an absorptive medium;
at least one of saturating at least a portion of the absorptive medium with a cleaning solution before the portion of the contaminated surface is covered with the absorptive medium, and saturating at least a portion of the absorptive medium with a cleaning solution after the portion of the contaminated surface is covered with the absorptive medium; and
applying steam to the saturated absorptive medium for a period of time to facilitate removing contaminants from the contaminated surface and to facilitate transferring the contaminants to the absorptive medium, wherein the saturated absorptive medium is substantially stationary relative to the contaminated surface as steam is applied to the saturated absorptive medium.

2. The method in accordance with claim 1, wherein applying steam to the saturated absorptive medium further comprises directing at least one steam jet from a steam jet head towards the saturated absorptive medium.

3. The method in accordance with claim 2, wherein directing a steam jet further comprises positioning the steam jet head a distance from the absorptive medium.

4. The method in accordance with claim 1, wherein applying steam to the saturated absorptive medium further comprises directing the steam through the saturated absorptive medium to facilitate forcing the cleaning solution towards the contaminated surface.

5. The method in accordance with claim 1, wherein applying steam to the saturated absorptive medium further comprises transferring contaminants from the contaminated surface to the absorptive medium via a capillary action.

6. The method in accordance with claim 1 further comprising removing the absorptive medium from the contaminated surface after the steam is applied thereto.

7. The method in accordance with claim 6 further comprising rinsing the contaminated surface after the absorptive medium is removed from the surface.

8. The method in accordance with claim 7, wherein rinsing the contaminated surface further comprises directing steam from a steam jet head towards the surface.

9. The method in accordance with claim 8 wherein directing steam further comprises directing steam from the steam jet head at a pressure of up to about 500 pounds per square inch (psi).

10. A method for cleaning a contaminated surface, said method comprising:
covering at least a portion of the contaminated surface with an absorptive medium;
at least one of saturating at least a portion of the absorptive medium with a cleaning solution before the portion of the contaminated surface is covered with the absorptive medium, and saturating at least a portion of the absorptive medium with a cleaning solution after the portion of the contaminated surface is covered with the absorptive medium;
applying steam to the saturated absorptive medium for a period of time such that contaminants are removed from the contaminated surface and transferred to the absorptive medium, wherein the saturated absorptive medium is substantially stationary relative to the contaminated surface as steam is applied to the saturated absorptive medium; and
applying at least one of pressure or friction to the saturated absorptive medium to facilitate removing contaminants from the contaminated surface.

11. The method in accordance with claim 10, applying steam to the saturated absorptive medium further comprises directing at least one steam jet from a steam jet head towards the saturated absorptive medium.

12. The method in accordance with claim 10, wherein applying steam to the saturated absorptive medium further comprises directing the steam through the saturated absorptive medium to facilitate forcing the cleaning solution towards the contaminated surface.

13. The method in accordance with claim 10, wherein applying steam to the saturated absorptive medium further comprises transferring contaminants from the contaminated surface to the absorptive medium via a capillary action.

14. The method in accordance with claim 10, wherein applying at least one of pressure or friction further comprises applying at least one of pressure or friction to the saturated absorptive medium simultaneously with applying steam to the saturated absorptive medium.

15. The method in accordance with claim 10, wherein applying at least one of pressure or friction further comprises applying at least one of pressure or friction to the saturated absorptive medium with a steam jet head configured to contact the saturated absorptive medium while applying steam thereto.

16. The method in accordance with claim 10 further comprising removing the absorptive medium from the contaminated surface after the steam is applied thereto.

17. The method in accordance with claim 16 further comprising rinsing the contaminated surface after the absorptive medium has been removed from the surface.

18. The method in accordance with claim 17, wherein rinsing the contaminated surface further comprises: covering the portion of the contaminated surface with a second absorptive medium;
at least one of saturating at least a portion of the second absorptive medium with a rinsing solution before the portion of the contaminated surface is covered with the second absorptive medium, and saturating at least a portion of the second absorptive medium with a rinsing solution after the portion of the contaminated surface is covered with the second absorptive medium; and
applying steam to the second absorptive medium for a period of time to facilitate removing the cleaning solution from the contaminated surface and to facilitate transferring the predetermined cleaning solution to the second absorptive medium.

19. The method in accordance with claim 18 wherein rinsing the contaminated surface further comprises applying at least one of pressure or friction to the second absorptive medium to facilitate removing the cleaning solution from the surface.

20. The method in accordance with claim 17, wherein rinsing the contaminated surface further comprises directing steam from a steam jet head towards the surface.
